(19) United States
(12) Patent Application Publication
(10) Pub. No.: US 2026/0102736 A1
(43) Pub. Date: Apr. 16, 2026

(54) HYDROGEN PURIFICATION SYSTEM AND METHOD

(71) Applicant: Cummins Emission Solutions Inc., Columbus, IN (US)

(72) Inventors: Matthew K. Volmerding, Columbus, IN (US); Dylan Scott Trandal, Columbus, IN (US)

(21) Appl. No.: 18/911,595

(22) Filed: Oct. 10, 2024

(51) Int. Cl. B01D 53/26; B01D 53/04; B01D 53/86; C01B 3/58

(52) U.S. Cl. CPC B01D 53/261; B01D 53/0446; B01D 53/0454; B01D 53/8671; C01B 3/58; B01D 2256/16; B01D 2257/104; B01D 2257/80; B01D 2259/4009; B01D 2259/402; B01D 2259/404; C01B 2203/043; C01B 2203/0435; C01B 2203/0495

(57) ABSTRACT

A hydrogen purification system includes a dryer system having a plurality of dryers each having an adsorption bed for drying hydrogen gas configured to adsorb moisture in the adsorption bed from the hydrogen gas in an adsorption mode. The dryer is configured to remove moisture from the adsorption bed in a regeneration mode. The plurality of dryers includes a first dryer group having a first dryer and a second dryer. The hydrogen purification system includes a conduit system configured to connect the plurality of dryers to a hydrogen gas feed and to a hydrogen gas discharge. The first dryer and the second dryer are arranged in parallel in the adsorption mode allowing parallel flow of the hydrogen gas through the first dryer and the second dryer. The first dryer and the second dryer are arranged in series in the regeneration mode allowing series flow of regeneration gas through the first dryer and the second dryer.

### BACKGROUND OF THE INVENTION

The subject matter herein relates generally to is directed towards a hydrogen purification system and method for regenerating an adsorber bed, and more particularly, to a system and method for regenerating an adsorber bed.

Hydrogen is used as an alternative power source in various applications, such as in powertrain devices including hydrogen combustion engines and hydrogen fuel cells. Hydrogen gas may be produced from various sources, such as electrolyzer systems that break down water molecules into hydrogen molecules and oxygen molecules using electricity. The hydrogen-rich gas contains primarily hydrogen gas with some oxygen gas and water, such as water vapor. It is desirable to purify the hydrogen-rich gas by passing the gas through a deoxo reactor to form water from trace oxygen in the hydrogen stream and a dryer to dry the gas using desiccant adsorption to remove moisture from the gas stream. After a period, the dryer bed will become saturated, at which time it is preferred that it be taken offline and switched to a regeneration mode. Hydrogen purification systems typically include two dryers such that when one bed is switched to regeneration mode the other bed can be switched to production mode to enable continuous hydrogen dehumidification.

The hydrogen purification system is designed to operate under various flow conditions at different flow rates. Some systems may be designed to have significant turndown, such as to as low as 5% of the maximum flow. Under low flow conditions through the dryer, flow distribution can become very poor leading to channeling through the dryer bed. The flow is non-uniform in the low flow condition and is typically concentrated near the wall region, decreasing performance and increasing energy consumption for operating the hydrogen purification system. The performance degradation increases in larger diameter dryer tanks compared to narrower diameter dryer tanks. Additionally, channeling leads to water breakthrough through the dryer bed before the bed capacity is saturated, leading to a premature need to regenerate the dryer bed.

### BRIEF DESCRIPTION OF THE INVENTION

In one embodiment, a hydrogen purification system is provided and includes a dryer system having a plurality of dryers each having an adsorption bed for drying hydrogen gas configured to adsorb moisture in the adsorption bed from the hydrogen gas in an adsorption mode. The dryer is configured to remove moisture from the adsorption bed in a regeneration mode. The plurality of dryers includes a first dryer group having a first dryer and a second dryer. The hydrogen purification system includes a conduit system configured to connect the plurality of dryers to a hydrogen gas feed and to a hydrogen gas discharge. The first dryer and the second dryer are arranged in parallel in the adsorption mode allowing parallel flow of the hydrogen gas through the first dryer and the second dryer. The first dryer and the second dryer are arranged in series in the regeneration mode allowing series flow of regeneration gas through the first dryer and the second dryer.

In another embodiment, a hydrogen purification system is provided and includes a dryer system that includes a plurality of dryers. Each dryer includes an adsorption bed for drying hydrogen gas. The dryer is configured to adsorb moisture in the adsorption bed from the hydrogen gas in an adsorption mode. The dryer is configured to remove moisture from the adsorption bed in a regeneration mode. The plurality of dryers includes a first dryer group having a first dryer and a second dryer. The hydrogen purification system includes a conduit system that includes pipes and control valves. The conduit system is configured to connect the plurality of dryers to a hydrogen gas feed and to a hydrogen gas discharge. The hydrogen purification system includes a controller operably coupled to the conduit system to control the control valves to control flow of gas through the pipes. The first dryer and the second dryer are arranged in parallel in the adsorption mode allowing parallel flow of gas through the first dryer and the second dryer. The regeneration mode includes an independent regeneration mode and a series regeneration mode. The controller operates the conduit system to supply regeneration gas flow to the first dryer independent of the second dryer in the independent regeneration mode. The controller operates the conduit system to supply regeneration gas flow from the first dryer to the second dryer in series in the series regeneration mode.

In a further embodiment, a method of purifying hydrogen gas using a hydrogen purification system is provided and includes a dryer system includes a plurality of dryers and a conduit system configured to connect the plurality of dryers to a hydrogen gas feed and to a hydrogen gas discharge. Each dryer includes an adsorption bed for drying hydrogen gas. The plurality of dryers includes a first dryer group includes a first dryer and a second dryer. The method adsorbs moisture in the adsorption beds of the first and second dryers from the hydrogen gas in an adsorption mode, The first dryer and the second dryer are arranged in parallel in the adsorption mode allowing parallel flow of the hydrogen gas through the first dryer and the second dryer. The method removes moisture from the adsorption beds of the first and second dryers in a regeneration mode. The first dryer and the second dryer are arranged in series in the regeneration mode allowing series flow of regeneration gas through the first dryer and the second dryer.

### BRIEF DESCRIPTION OF THE DRAWINGS

FIG. 1 depicts a gas production system including a hydrogen purification system (HPS) in accordance with an exemplary embodiment.

FIG. 2 is a front perspective view of the HPS in accordance with an exemplary embodiment.

FIG. 3 is a rear perspective view of the HPS in accordance with an exemplary embodiment.

FIG. 4 is a diagram of the HPS in accordance with an exemplary embodiment.

FIG. 5 illustrates a dryer group of the dryers in accordance with an exemplary embodiment showing the dryer group in an adsorption mode.

FIG. 6 illustrates the dryer group in a first regeneration mode in which the first dryer is operating in an independent regeneration mode in accordance with an exemplary embodiment.

FIG. 7 illustrates the dryer group in a second regeneration mode in which the second dryer is operating in an independent regeneration mode in accordance with an exemplary embodiment.

FIG. 8 illustrates the dryer group in a third regeneration mode in which the first dryer and the second dryer are operating in a series regeneration mode in accordance with an exemplary embodiment.

FIG. 9 illustrates the dryer group in a fourth regeneration mode in which the second dryer and the first dryer are operating in a series regeneration mode in accordance with an exemplary embodiment.

FIG. 10 is a diagram of the HPS in accordance with an exemplary embodiment.

FIG. 11 is a diagram of the HPS in accordance with an exemplary embodiment.

FIG. 12 is a diagram of the HPS in accordance with an exemplary embodiment.

### DETAILED DESCRIPTION OF THE INVENTION

Following below are more detailed descriptions of various concepts related to, and implementations of, methods, apparatuses, and for providing a hydrogen purification system (HPS). The various concepts introduced above and discussed in greater detail below may be implemented in any of a number of ways, as the described concepts are not limited to any particular manner of implementation. Examples of specific implementations and applications are provided primarily for illustrative purposes.

In order to produce pure, or nearly pure, hydrogen, an electrolyzer uses electricity to break down water molecules into hydrogen molecules and oxygen molecules. Electrolyzer systems produce output gases, referred to herein as “electrolysis gases.” The electrolysis gases are provided to a downstream device for further processing. In an HPS, the primary electrolysis gas of concern includes hydrogen molecules, but may include impurities, such as oxygen molecules and/or water molecules and/or carbon dioxide molecules and/or other molecules, such as argon gas molecules. The HPS is used to remove the impurities in the primary electrolysis gas.

In an HPS, a reactor may be used to remove impurities from the electrolysis gas (e.g., from the hydrogen gas produced by the electrolyzer). The reactor may include one or more catalyst members configured to facilitate converting the impurities. For example, the catalyst members may facilitate converting oxygen gas into water, such as via a recombination reaction. In an HPS, the gas production system 10 includes a dryer system including a plurality of dryers having adsorption beds for drying compressed humidified hydrogen. The dryers are configured to remove water impurities from the impurity-reduced gas. The HPS includes a system and method for regenerating the adsorber beds.

Implementations described herein are related to a HPS including a dryer system including a plurality of dryers each including an adsorption bed for drying hydrogen gas. The dryer is configured to adsorb moisture in the adsorption bed from the hydrogen gas in an adsorption mode during an adsorption process and the dryer is configured to remove moisture from the adsorption bed in a regeneration mode during a regeneration process. The plurality of dryers include a first dryer group including a first dryer and a second dryer. The HPS includes a conduit system configured to connect the plurality of dryers to a hydrogen gas feed and to a hydrogen gas discharge. The first dryer and the second dryer are arranged in parallel in the adsorption mode allowing parallel flow of the hydrogen gas through the first dryer and the second dryer. The first dryer and the second dryer are arranged in series in the regeneration mode allowing series flow of regeneration gas through the first dryer and the second dryer.

Implementations described herein are related to a HPS including a dryer system including a plurality of dryers each including an adsorption bed for drying hydrogen gas. The dryer is configured to adsorb moisture in the adsorption bed from the hydrogen gas in an adsorption mode during an adsorption process. The dryer is configured to remove moisture from the adsorption bed in a regeneration mode during a regeneration process. The plurality of dryers include a first dryer group including a first dryer and a second dryer. The HPS includes conduit system including pipes and control valves configured to connect the plurality of dryers to a hydrogen gas feed and to a hydrogen gas discharge. The HPS includes a controller operably coupled to the conduit system to control the control valves to control flow of gas through the pipes. The first dryer and the second dryer are arranged in parallel in the adsorption mode allowing parallel flow of gas through the first dryer and the second dryer. The regeneration mode includes an independent regeneration mode and a series regeneration mode. The controller operates the conduit system to supply regeneration gas flow to the first dryer independent of the second dryer in the independent regeneration mode. The controller operates the conduit system to supply regeneration gas flow from the first dryer to the second dryer in series during the series regeneration mode.

Implementations described herein are related to a method of purifying hydrogen gas using a HPS including a dryer system including a plurality of dryers and a conduit system configured to connect the plurality of dryers to a hydrogen gas feed and to a hydrogen gas discharge, wherein each dryer including an adsorption bed for drying hydrogen gas, and wherein the plurality of dryers include a first dryer group including a first dryer and a second dryer. The method includes adsorbing moisture in the adsorption beds of the first and second dryers from the hydrogen gas in an adsorption mode during an adsorption process, wherein the first dryer and the second dryer are arranged in parallel during the adsorption process allowing parallel flow of the hydrogen gas through the first dryer and the second dryer. The method includes removing moisture from the adsorption beds of the first and second dryers in a regeneration mode during an regeneration process, wherein the first dryer and the second dryer are arranged in series during the regeneration process allowing series flow of regeneration gas through the first dryer and the second dryer.

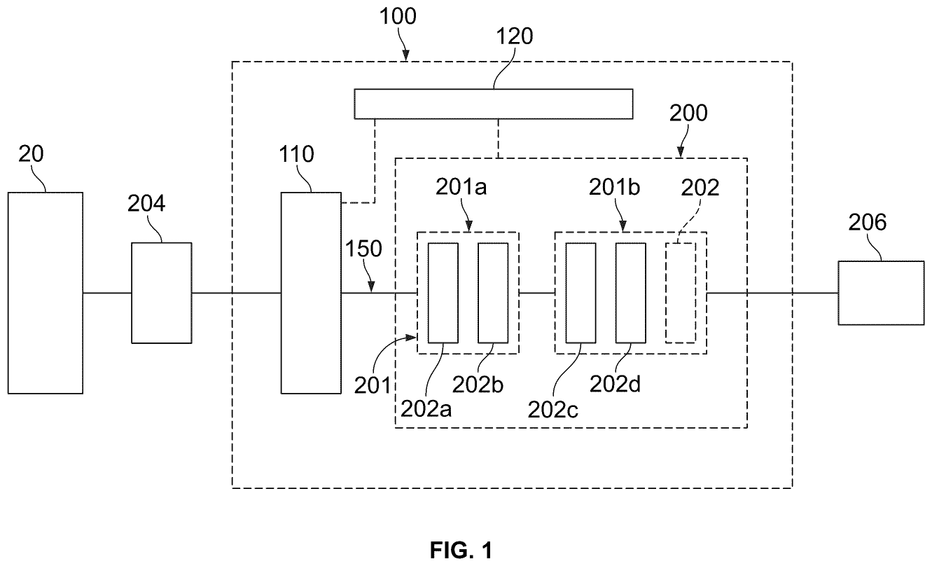

FIG. 1 depicts a gas production system 10 (e.g., a hydrogen production system) including a hydrogen purification system (HPS) 10 in accordance with an exemplary embodiment. In an exemplary embodiment, the gas production system 10 includes an electrolyzer 20. The electrolyzer 20 is configured to decompose water into an electrolysis gas. The electrolysis gas includes hydrogen gas as a primary electrolysis gas and a secondary electrolysis gas that includes oxygen gas. The primary electrolysis gas may include oxygen gas impurities and/or water impurities. Other types of gas production systems may be used in alternative embodiments to provide a supply of hydrogen gas.

The HPS 100 includes a reactor 110 configured to receive the electrolysis gas from the electrolyzer 20 and a dryer system 200 that receives purified hydrogen gas from the reactor 110. The reactor 110 is configured to treat the electrolysis gas (e.g., the hydrogen gas with oxygen gas impurities and/or water impurities). As is explained in more detail herein, the treatment may facilitate the removal of at least a portion of the impurities in the electrolysis gas. The reactor 110 is configured to provide an impurity-reduced gas downstream through the HPS 100 for further processing. The dryer system 200 is configured to remove water impurities from the impurity-reduced gas. In an exemplary embodiment, the HPS 100 includes a conduit system 150 (e.g., line system, pipe system, etc.). The conduit system 150 is configured to facilitate routing of the electrolysis gas produced by the electrolyzer 20 through the reactor 110, through the dryer system 200, and through other system components.

The dryer system 200 includes a plurality of dryers 202 for drying hydrogen gas, such as during an adsorption process. For example, each dryer 202 includes an adsorption bed, such as a desiccant bed, for drying hydrogen gas. The dryer 202 is configured to adsorb moisture in the adsorption bed from the hydrogen gas during an adsorption process and is configured to remove moisture from the adsorption bed during a regeneration process. The conduit system 150 of the HPS 100 is connected to the dryers 202. The conduit system 150 includes pipes, control valves, fittings, and the like, configured to connect the plurality of dryers 202 to other components, such as to a hydrogen gas feed 204, and/or the reactor 110, and/or the electrolyzer 20, and/or a hydrogen gas discharge 206. The hydrogen gas discharge 206 may be a storage tank for later use of the hydrogen gas. The hydrogen gas discharge 206 may be an output to another system for on demand use of the hydrogen gas. The HPS 100 includes a control system 120 operably coupled to the conduit system 150 to operate the control valves (e.g., open/close) to control flow of gas through the pipes.

In an exemplary embodiment, the dryers 202 are arranged in dryer groups 201. For example, each dryer group 201 may include at least two of the dryers 202. The dryers 202 within each group 201 may be operated in the same mode during operation of the HPS 100 (e.g., adsorption mode versus regeneration mode). In an exemplary embodiment, the dryers 202 within each group 201 are connected to the conduit system 150 to selectively operate in series and in parallel (e.g., based on opening and closing of control valves to control gas flow). For example, a first dryer group 201a may include a first dryer 202a and a second dryer 202b and a second dryer group 201b may include a third dryer 202c and a fourth dryer 202d. The first dryer group 201a and/or the second dryer group 201b may include additional dryers 202, such as three, four, or more dryers 202, which may be operated together as a group, such as in either the adsorption mode or the regeneration mode. By providing a plurality of the dryers 202 within each group 201, each of the dryers 202 may be sized smaller than conventional hydrogen purification dryer systems that typically include only two dryers operable with one of the dryers in the adsorption mode and the other dryer in the regeneration mode. For example, the dryers 202 may have a smaller diameter and/or a smaller height allowing use of the dryer system 200 in applications having size or space restrictions. The use of smaller dryers 202 may allow operation at lower flow conditions than conventional, larger dryers. The use of smaller dryers 202 may have improved performance by reducing risk of channeling of the adsorption bed. The use of smaller dryers 202 may have improved regeneration by reducing time for the regeneration process and/or reduced energy consumption for the regeneration process.

In an exemplary embodiment, the first dryer 202a and the second dryer 202b are arranged in parallel during the adsorption process allowing parallel flow of gas through the first dryer 202a and the second dryer 202b. In an exemplary embodiment, the first dryer 202a and the second dryer 202b may be arranged in series during the regeneration process allowing serial flow of gas through the first dryer 202a and the second dryer 202b.

The series flow of the regeneration gas through the first dryer 202a and the second dryer 202b may reduce the regeneration time of the first dryer group 201a. For example, both dryers 202a, 202b may undergo regeneration at the same time. The series flow of the regeneration gas through the first dryer 202a and the second dryer 202b may lower energy consumption to perform the regeneration process for the first dryer group 201a. For example, less total energy may be needed to heat regeneration gas by routing the regeneration gas in series through both of the dryers 202a, 202b.

In an exemplary embodiment, the series flow of the regeneration gas through the first dryer 202a and the second dryer 202b may be phased. For example, at onset of the regeneration process, the regeneration gas flow may be routed only through the first dryer 202a without passing such regeneration gas flow through the second dryer 202b. Because such early stage regeneration gas flow discharged from the first dryer 202a has a high moisture content, it may be desirable to avoid routing such early stage regeneration gas flow through the second dryer 202b to avoid sending excessive moisture to the second dryer 202b, such as to preserve the desiccant bed life of the second dryer 202b. Later stage regeneration gas flow discharged from the first dryer 202a has a lower moisture content. Such later stage regeneration gas flow may be supplied to the second dryer 202b for series flow through both the first dryer 202a and the second dryer 202b.

In an exemplary embodiment, the regeneration process includes an independent regeneration process (where one or both dryers 202a, 202b may be regenerated independently by singular gas flow) and a series regeneration process (where both dryers 202a, 202b are regenerated by series flow). The control system 120 operates the conduit system 150 to supply regeneration gas flow to the first dryer 202a independent of the second dryer 202b (and/or to supply regeneration gas flow to the second dryer 202b independent of the first dryer 202a) in the independent regeneration process. The control system 120 operates the conduit system 150 to supply regeneration gas flow from the first dryer 202a to the second dryer 202b (or from the second dryer 202b to the first dryer 202a) in series during the series regeneration process.

In other various embodiments, the first dryer 202a and the second dryer 202b may be arranged in parallel during the regeneration process allowing parallel flow of regeneration gas through both the first dryer 202a and the second dryer 202b. For example, parallel regeneration flow may occur prior to series regeneration flow at different stages of the regeneration process. Parallel regeneration of the first and second dryers 202a, 202b may reduce the total regeneration process time.

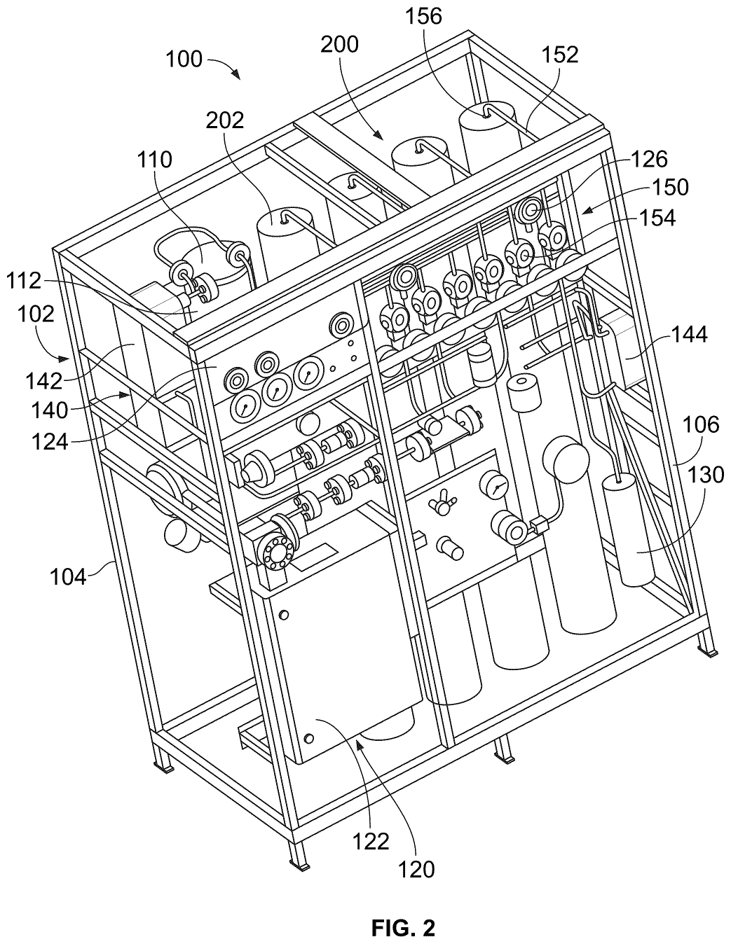

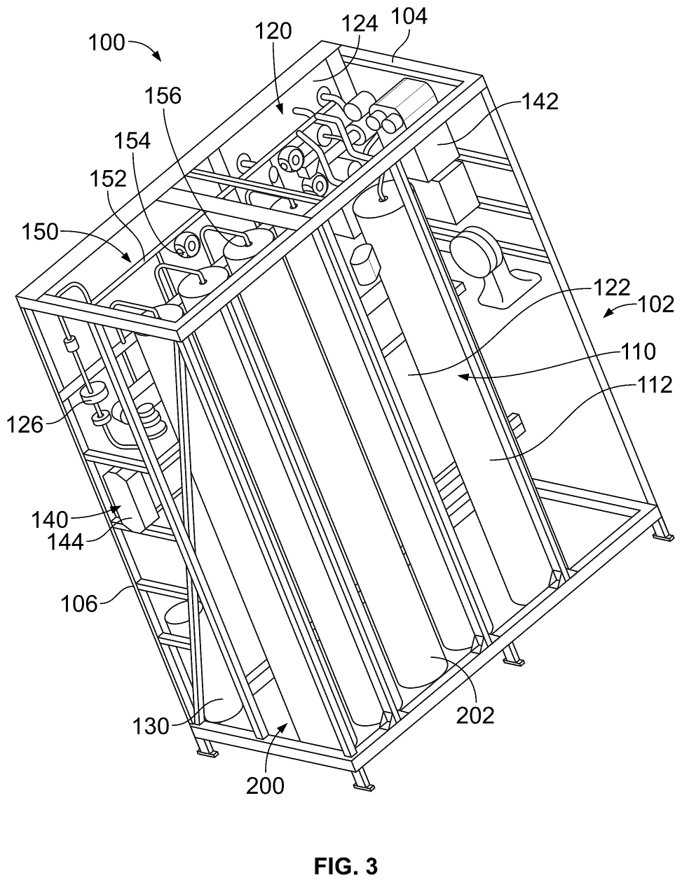

FIG. 2 is a front perspective view of the HPS 100 in accordance with an exemplary embodiment. FIG. 3 is a rear perspective view of the HPS 100 in accordance with an exemplary embodiment. In an exemplary embodiment, the HPS 100 includes a skid 102, the reactor 110 coupled to the skid 102, the dryer system 200 coupled to the skid 102, the control system 120 coupled to the skid 102, a demister 130 coupled to the skid 102, and a heat exchange system 140 coupled to the skid 102. The HPS 100 may include other components, such as pumps or compressors (not shown) to pressurize the gas stream through the HPS 100.

The skid 102 includes frame members 104 forming a frame 106 used to support the components of the HPS 100. The skid 102 may include panels or walls (not shown) in closing various components of the HPS 100. In an exemplary embodiment, the skid 102 may be mobile, such as being movable by a forklift or other transport vehicle. The skid 102 may be sized and shaped to fit in a particular space, such as a shipping container, such that the HPS 100 may be readily deployed and integrated into the gas production system 10. In alternative embodiments, the skid 102 may be purpose built into a fixed location, such as into a building or facility. In the illustrated embodiment, the skid 102 is a generally rectangular shape. However, the skid 102 may have other shapes in alternative embodiments.

The reactor 110 is coupled to the skid 102. For example, the reactor 110 may be mounted to one or more of the frame members 104. The reactor 110 is configured to facilitate removing impurities from a gas stream, such as the gas stream produced by the electrolyzer 20, to produce an impurity-reduced gas. In the HPS 100, the reactor 110 facilities removing oxygen from the gas stream and produces an oxygen-reduced hydrogen gas stream. In an exemplary embodiment, the reactor 110 includes a tank 112. The tank 112 may hold a catalyst to remove impurities from the hydrogen gas stream. In an exemplary embodiment, the reactor 110 is a deOxo reactor configured to remove oxygen from the gas stream using a platinum or palladium based catalyst to catalytically recombine trace oxygen in the hydrogen gas stream with hydrogen to form water vapor. Other types of reactors 110 may be used to remove impurities from the hydrogen gas stream.

The conduit system 150 is a line system or pipe system configured to facilitate routing of the gas streams through the HPS 100. For example, the conduit system 150 includes pipes 152, control valves 154, fittings 156, and the like to control the flow of the gas from the hydrogen gas feed 204 (for example, from the electrolyzer 20), through the reactor 110, through the dryer system 200, through the demister 130, through the heat exchange system 140, and to a downstream component or system, such as the hydrogen gas discharge 206. The control valves 154 may be opened and closed to control the flow of the gas streams through the pipes 152.

The demister 130 is coupled to the skid 102. For example, the demister 130 may be mounted to one or more of the frame members 104. The demister 130 is used to separate liquid water from gas. The demister 130 may be provided downstream of the dryers 202 in the regeneration cycle to remove the moisture from the gas stream during the regeneration process.

The heat exchange system 140 includes components coupled to the skid 102. For example, the components of the heat exchange system 140 may be mounted to one or more of the frame members 104. In an exemplary embodiment, the heat exchange system 140 includes one or more heaters 142 used to increase temperature of the gas stream. For example, the heaters 142 may be used to increase the temperature of the gas stream upstream of the reactor 110 to provide a heated gas stream to the reactor 110 for the impurity removal process. In an exemplary embodiment, the heaters 142 may be used to increase the temperature of the gas stream upstream of the dryers 202 in the regeneration cycle to provide a heated gas stream to the dryers 202 for the regeneration process.

In an exemplary embodiment, the heat exchange system 140 includes one or more heat exchangers 144 used to either heat up or cool down the gas stream for processing by the various components of the HPS 100. For example, the heat exchangers 144 may be used to increase the temperature of the gas stream upstream of the reactor 110. The heat exchangers 144 may be used to decrease the temperature of the gas stream downstream of the reactor 110. The heat exchangers 144 may be used to decrease the temperature of the gas stream upstream of the dryers 202 in the adsorption cycle. The heat exchangers 144 may be used to increase the temperature of the gas stream upstream of the dryers 202 in the regeneration cycle. The heat exchangers 144 may be used to decrease the temperature of the gas stream downstream of the dryers 202 in the regeneration cycle. The heat exchangers 144 may be used to decrease the temperature of the gas stream upstream of the demister 130. The heat exchangers 144 may be used to increase the temperature of the gas stream downstream of the demister 130.

The control system 120 includes a controller 122, a control panel 124, sensors 126, transmitters (not shown), and other elements for control of the various components of the HPS 100. The control system 120 may include instruments, gauges, a display screen, or other type of output device to display readings or other parameters to the operator of the HPS 100.

The controller 122 includes a control circuit or driver to facilitate operating the operable components of the HPS 100. For example, the controller 122 includes a processing circuit having a processor and a memory. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing a processor, ASIC, FPGA, etc. with program instructions. The memory may include a memory chip, Electrically Erasable Programmable Read-Only Memory (EEPROM), Erasable Programmable Read Only Memory (EPROM), flash memory, or any other suitable memory from which the controller 122 can read instructions. The instructions may include code from any suitable programming language. The memory may include various modules that include instructions that are configured to be implemented by the processor.

The control panel 124 is communicable with the controller 122. In an exemplary embodiment, the control panel 124 includes one or more inputs (e.g., keyboard, keypad, touch screen, dials, knobs, a pointer device, etc.). The inputs receive commands, instructions, requests, or other types of inputs from the operator. In an exemplary embodiment, the control panel 124 includes a display device (e.g., screen, monitor, touch screen, heads up display (HUD), indicator light, etc.). The display device may be configured to change state in response to receiving information from the controller 122. For example, the display device may be configured to change between a static state and an alarm state based on a communication from the controller 122. By changing state, the display device may provide an indication to a user of a status of one or more components or parameters of the HPS 100 or the gas stream.

The sensors 126 sense operating parameters of the components of the HPS 100 and/or the gas stream. The sensors 126 may be integrated into various components of the HPS 100, such as the reactor 110, the dryers 202, the demister 130, the heaters 142, the heat exchangers 144, the pipes 152, the control valves 154, and the like. Various types of sensors may be incorporated into the HPS 100. For example, the sensors 126 may include temperature sensors, moisture sensors, flow rate sensors, position sensors, voltage sensors, or other types of sensors. The sensors 126 are configured to measure (e.g., sense, detect, etc.) various parameters (e.g., operating temperature, gas temperature, gas moisture content, gas flow rate, etc.). The sensors 126 are operably coupled to the controller 122. The controller 122 is configured to receive signals from the sensors 126 to control operation of the components based on the signals received from the sensors 126.

The transmitters are communicatively coupled to the controller 122. The transmitters may be connected to other components of the HPS 100, such as the control valves 154, to control operation of such components. The transmitters may be wirelessly connected to the components or have wired connections to the components. The transmitters transmit control signals to control operations of the components. For example, the transmitters 120 may open and close the control valves 154 to control the flow of the gas stream through the HPS 100, such as to control the adsorption process and/or the regeneration process for the dryers 202. The transmitters may be connected to other components, such as the heaters 142 to control temperatures of the gas streams, pumps or compressors to control flow rates and/or pressures of the gas streams, and the like.

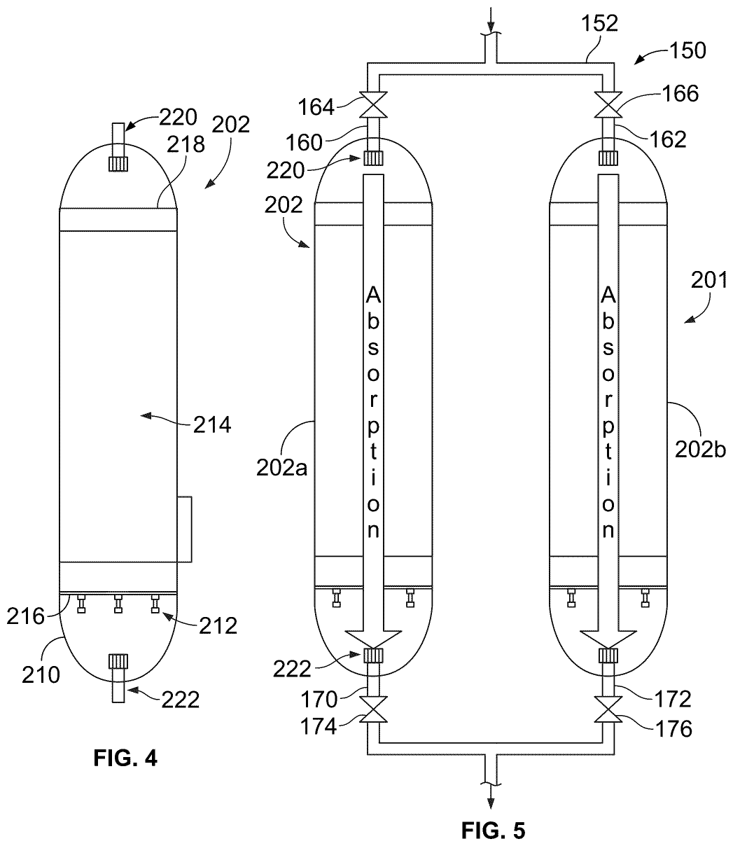

FIG. 4 is a sectional view of the dryer 202 in accordance with an exemplary embodiment. The dryer 202 includes a tank 210 having a chamber 212 holding an adsorption bed 214. The dryer 202 includes a support structure 216 below the adsorbent bed 214 and a floating screen 218 above the adsorbent bed 214. The adsorbent bed 214 is contained between the support structure 216 and the floating screen 218. The dryer 202 includes an upper distributor 220 at the top of the tank 210 and a lower distributor 222 at the bottom of the tank 210. During the adsorption process, the upper distributor 220 is an inlet of the dryer 202 and the lower distributor 222 is an outlet of the dryer 202. During the regeneration process, the lower distributor 222 is an inlet of the dryer 202 and the upper distributor 220 is an outlet of the dryer 202.

The adsorbent bed 214 is used to adsorb moisture from the gas stream as the gas stream passes through the adsorbent bed 214. In an exemplary embodiment, the adsorption bed 214 may have multiple layers, such as a silica gel material layer (e.g., alumino-silicate layer) and a microporous, crystalline aluminosilicate material layer (e.g., zeolite layer). The adsorption bed 214 may include additional layers and/or other types of layers in alternative embodiments.

FIG. 5 illustrates a dryer group 201 of the dryers 202 in accordance with an exemplary embodiment showing the dryer group 201 in an adsorption mode. In the illustrated embodiment, the dryer group 201 includes a pair of the dryers 202 including the first dryer 202a and the second dryer 202b. However, the dryer group 201 may include additional dryers 202 in alternative embodiments. In an exemplary embodiment, the first dryer 202a and the second dryer 202b are arranged in parallel during the adsorption process allowing parallel flow of gas through the first dryer 202a and the second dryer 202b.

The pipes 152 of the conduit system 150 are coupled to the inlets and the outlets of the dryers 202. During the adsorption process, the upper distributors 220 define the inlets for the dryers 202 and the lower distributors 222 define the outlets for the dryers 202.

In an exemplary embodiment, a first supply pipe 160 is coupled to the inlet (at 220a) of the first dryer 202a and a second supply pipe 162 is coupled to the inlet (at 220b) of the second dryer 202b. A supply connecting pipe 161 is connected between the first and second supply pipes 160, 162 to split the gas stream and feed the split gas stream to both the first and second supply pipes 160, 162. A first supply valve 164 is coupled to the first supply pipe 160 to control gas flow through the first supply pipe 160. A second supply valve 166 is coupled to the second supply pipe 162 to control gas flow through the second supply pipe 162. By splitting the gas feed to the inlets of both dryers 202a, 202b, both of the dryers 202a, 202b may simultaneously operate in the adsorption mode to adsorb moisture from the gas streams passing through the respective dryers 202a, 202b. The simultaneous gas flow (e.g., from top to bottom) allows the dryers 202a, 202b to operate in parallel during the adsorption process. Providing both dryers 202a, 202b, operating in the adsorption mode, may increase the amount of gas throughput in the HPS system 100. For example, the gas flow rate and/or the gas volume processed through the HPS system 100 may be increased by utilizing multiple dryers 202a, 202b in the adsorption mode.

In an exemplary embodiment, a first discharge pipe 170 is coupled to the outlet (at 222a) of the first dryer 202a and a second discharge pipe 172 is coupled to the outlet (at 222b) of the second dryer 202b. A discharge connecting pipe 171 is connected between the first and second discharge pipes 170, 172 to receive and combine the discharged gas stream from both the first and second discharge pipes 170, 172. A first discharge valve 174 is coupled to the first discharge pipe 170 to control gas flow through the first discharge pipe 170. A second discharge valve 176 is coupled to the second discharge pipe 172 to control gas flow through the second discharge pipe 172.

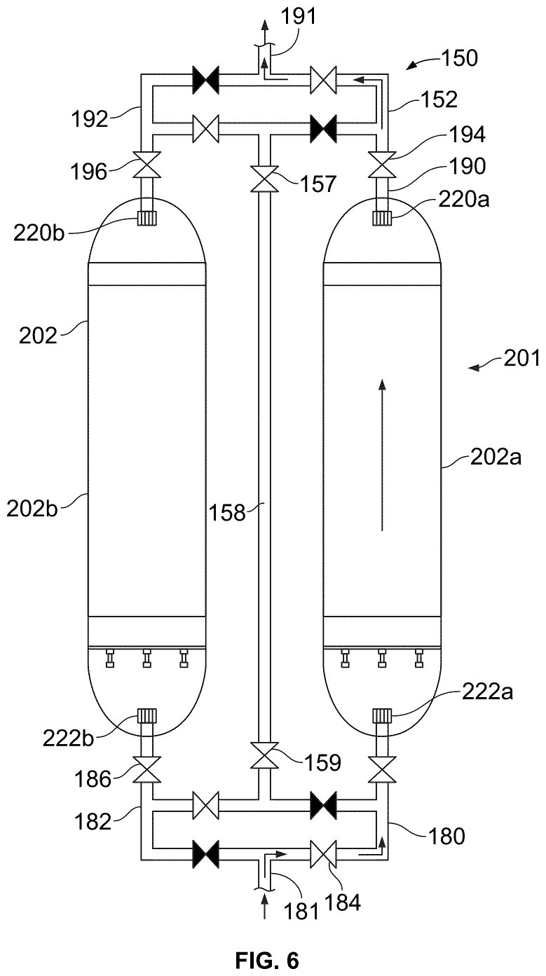

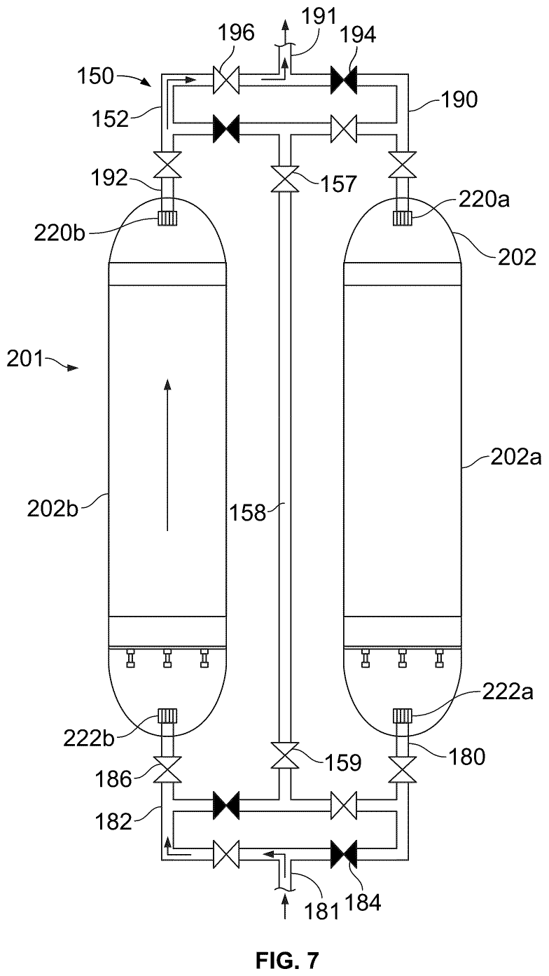

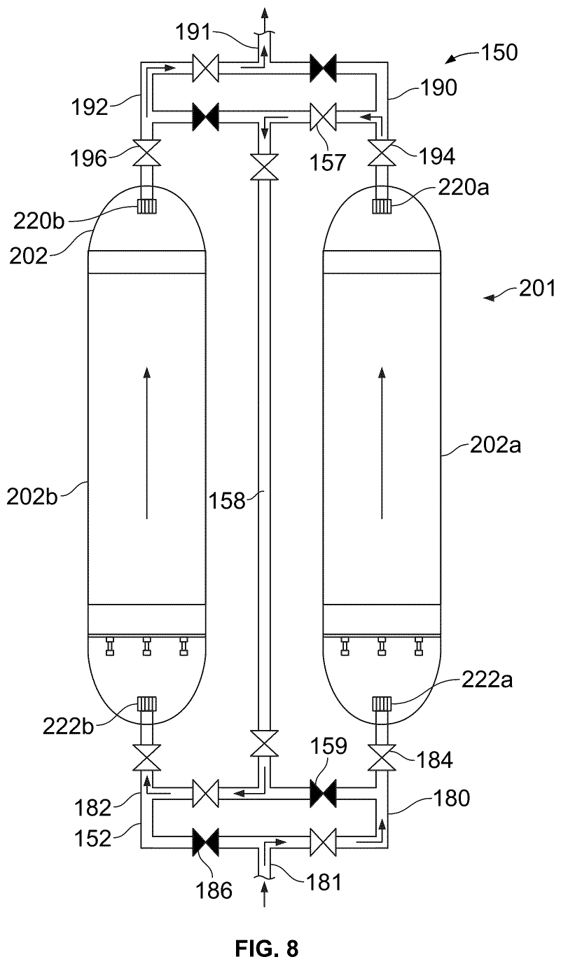

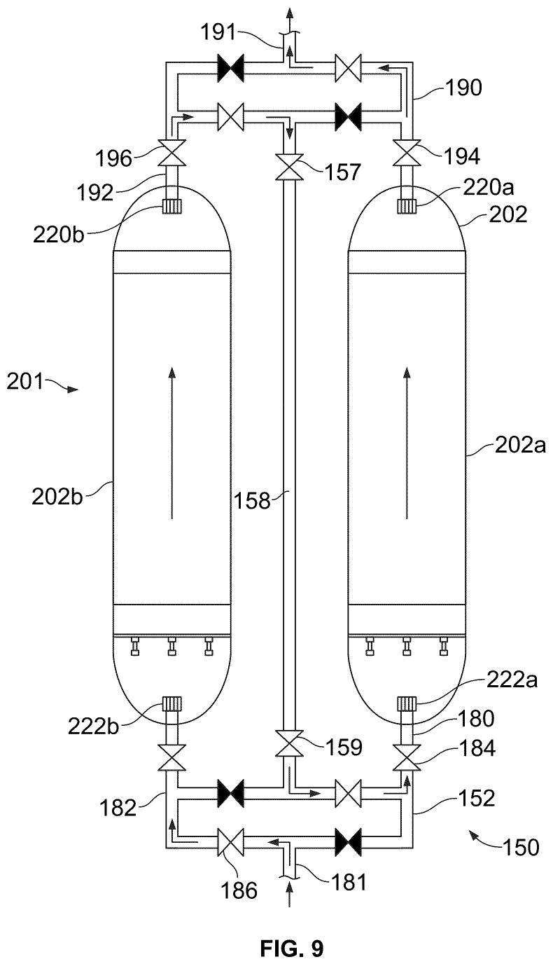

FIGS. 6-9 illustrate a dryer group 201 of the dryers 202 in accordance with an exemplary embodiment showing the dryer group 201 in various regeneration modes. FIG. 6 illustrates the dryer group 201 in a first regeneration mode in which the first dryer 202a is operating in an independent regeneration mode. FIG. 7 illustrates the dryer group 201 in a second regeneration mode in which the second dryer 202b is operating in an independent regeneration mode. FIG. 8 illustrates the dryer group 201 in a third regeneration mode in which the first dryer 202a and the second dryer 202b are operating in a series regeneration mode. FIG. 9 illustrates the dryer group 201 in a fourth regeneration mode in which the second dryer 202b and the first dryer 202a are operating in a series regeneration mode. In the independent regeneration modes, only one of the dryers 202 is receiving the regeneration gas to regenerate such dryer 202. In the series regeneration modes, the regeneration gas is routed through both of the dryers 202. For example, in FIG. 8, the regeneration gas is initially routed through the first dryer 202a and then through the second dryer 202b, whereas, in FIG. 9, the regeneration gas is initially routed through the second dryer 202b and then through the first dryer 202a.

In the illustrated embodiment, the dryer group 201 includes a pair of the dryers 202 including the first dryer 202a and the second dryer 202b. However, the dryer group 201 may include additional dryers 202 in alternative embodiments.

The pipes 152 of the conduit system 150 are coupled to the inlets and the outlets of the dryers 202. During the regeneration process, the lower distributors 222 define the inlets for the dryers 202 and the upper distributors 220 define the outlets for the dryers 202 to allow bottom to top flow of the regeneration gas through the dryers 202. In an exemplary embodiment, the conduit system 150 includes a dryer connecting pipe 158 between the first dryer 202a and the second dryer 202b. The dryer connecting pipe 158 allows series flow of the regeneration gas between the first and second dryers 202a, 202b, when utilized. Flow control valves 157, 159 control flow through the dryer connecting pipe 158, such as to control flow from the first dryer 202a to the second dryer 202b, or vice versa.

In an exemplary embodiment, a first supply pipe 180 is coupled to the inlet (at 222a) of the first dryer 202a and a second supply pipe 182 is coupled to the inlet (at 222b) of the second dryer 202b. A supply connecting pipe 181 is connected between the first and second supply pipes 180, 182 to feed the gas stream to both the first and second supply pipes 180, 182. A first supply valve 184 is coupled to the first supply pipe 180 to control gas flow through the first supply pipe 180. A second supply valve 186 is coupled to the second supply pipe 182 to control gas flow through the second supply pipe 182. In the first regeneration mode (FIG. 6—first dryer 202a operating in an independent regeneration mode), the first supply valve 184 is opened to allow flow to the first dryer 202a and the second supply valve 186 is closed to restrict flow to the second dryer 202b. In the second regeneration mode (FIG. 7—second dryer 202b operating in an independent regeneration mode), the second supply valve 186 is opened to allow flow to the second dryer 202b and the first supply valve 184 is closed to restrict flow to the first dryer 202a.

In an exemplary embodiment, a first discharge pipe 190 is coupled to the outlet (at 220a) of the first dryer 202a and a second discharge pipe 192 is coupled to the outlet (at 220b) of the second dryer 202b. A discharge connecting pipe 191 is connected between the first and second discharge pipes 190, 192 to receive the gas stream from the first and second discharge pipes 190, 192 depending on which of the dryers 202a, 202b is being regenerated. A first discharge valve 194 is coupled to the first discharge pipe 190 to control gas flow through the first discharge pipe 190. A second discharge valve 196 is coupled to the second discharge pipe 192 to control gas flow through the second discharge pipe 192.

In an exemplary embodiment, in the series regeneration mode (FIGS. 8 and 9), the regeneration gas is routed through both of the dryers 202. For example, in FIG. 8, the regeneration gas is initially routed through the first dryer 202a and then through the second dryer 202b. The regeneration gas is routed from the outlet 220a of the first dryer 202a to the inlet 222b of the second dryer 202b. In FIG. 9, the regeneration gas is initially routed through the second dryer 202b and then through the first dryer 202a. The regeneration gas is routed from the outlet 220b of the second dryer 202b to the inlet 222a of the first dryer 202a. As such, a single regeneration gas stream is able to regenerate both the first dryer 202a and the second dryer 202b. The single regeneration gas stream is only heated once. As such, the series flow of the regeneration gas through the first dryer 202a and the second dryer 202b may lower energy consumption to perform the regeneration process for the first dryer group 201a. For example, less total energy may be needed to heat the regeneration gas by routing the regeneration gas in series through both of the dryers 202a, 202b.

In an exemplary embodiment, the series flow of the regeneration gas through the first dryer 202a and the second dryer 202b may be phased. For example, with reference to FIGS. 6 and 8, at onset of the regeneration process, the process is the independent regeneration process and the regeneration gas flow may be routed only through the first dryer 202a (FIG. 6) without passing such regeneration gas flow through the second dryer 202b. Because such early stage regeneration gas flow discharged from the first dryer 202a has a high moisture content, the discharge gas flow bypasses the second dryer 202b and is routed downstream to the demister 130 rather than being routed, in series, to the second dryer 202b through the dryer connecting pipe 158. As such, the system avoids sending excessive moisture to the second dryer 202b, which may preserve the desiccant bed life of the second dryer 202b. When the moisture content of the discharge gas from the first dryer 202a is lower, such as below a threshold moisture content, the process may enter the series regeneration process and the discharge gas flow may be routed, in series (FIG. 8), to the second dryer 202b through the dryer connecting pipe 158. For example, the flow control valves 157, 159 may be opened to allow flow through the dryer connecting pipe 158. Such later stage regeneration gas flow is supplied to the second dryer 202b for series flow through both the first dryer 202a and the second dryer 202b to avoid wasting the heated regeneration gas flow and instead using the heated regeneration gas flow for regenerating the second dryer 202b. Such a process of switching from the independent regeneration mode to the series regeneration mode reduces the total energy consumption for regenerating the dryer group 201 (for example, both dryers 202a, 202b).

Similarly, with reference to FIGS. 7 and 9, at onset of the regeneration process, the regeneration gas flow may be routed only through the second dryer 202b (FIG. 7) without passing such regeneration gas flow through the first dryer 202a. When the moisture content of the discharge gas from the second dryer 202b is lower, such as below a threshold moisture content, the discharge gas flow may be routed, in series (FIG. 9), to the second dryer 202b through the dryer connecting pipe 158. For example, the flow control valves 157, 159 may be opened to allow flow through the dryer connecting pipe 158. Such later stage regeneration gas flow is supplied to the first dryer 202a for series flow through both the second dryer 202b and the first dryer 202a to avoid wasting the heated regeneration gas flow and instead using the heated regeneration gas flow for regenerating the first dryer 202a. Such a process of switching from independent regeneration mode to series regeneration mode reduces the total energy consumption for regenerating the dryer group 201 (for example, both dryers 202a, 202b).

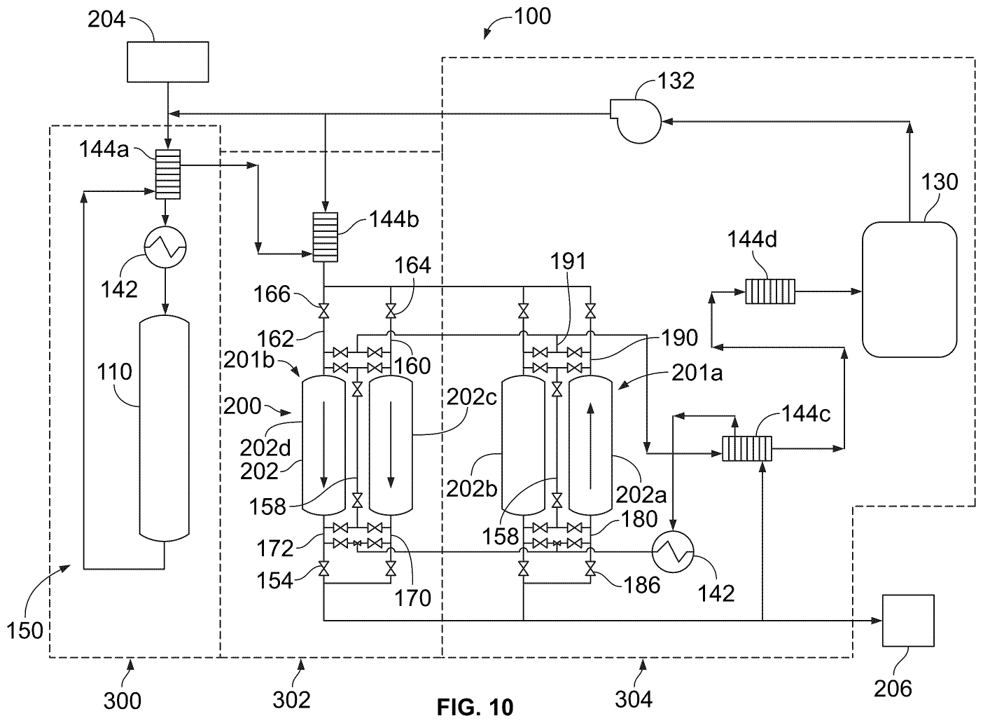

FIG. 10 is a diagram of the HPS 100 in accordance with an exemplary embodiment. FIG. 10 shows the reactor 110, the dryer system 200, the heaters 142, the heat exchangers 144, and the demister 130, as well as the conduit system 150 connecting the components of the HPS 100. FIG. 10 shows a reactor circuit 300, an adsorption circuit 302, and a regeneration circuit 304 of the HPS 100. FIG. 10 shows the first dryer group 201a of the dryer system 200 in the regeneration mode and the second dryer group 201b of the dryer system 200 in the adsorption mode. In an exemplary embodiment, the controller 122 is operably coupled to the control valves 154 to open and close the control valves 154 to control the flow of gas through the reactor circuit 300, the adsorption circuit 302, and the regeneration circuit 304.

The reactor circuit 300 includes the reactor 110, the heater 142 from the reactor 110, the reactor heat exchanger(s) 144a for the reactor 110, and subassembly of the conduit system 150 to interconnect the components of the reactor circuit 300. In the reactor circuit 300, the gas flows from the hydrogen gas feed 204 to the reactor 110 and then flows from the reactor 110 to the adsorption circuit 302. In an exemplary embodiment, the heater 142 of the reactor circuit 300 is located upstream of the reactor 110 to heat the gas flow prior to the reactor 110. For example, the heater 142 may heat the gas flow to approximately 40° C. In an exemplary embodiment, the heat exchanger 144a is located upstream of the heater 142 to preheat the gas flow, which may reduce the energy input to heat the gas flow to the reactor 110. In the illustrated embodiment, the gas discharge from the reactor 110 is routed to the heat exchanger 144a for heat input to the heat exchanger. As such, the gas discharge from the reactor 110 may be cooled prior to routing to the adsorption circuit 302.

The adsorption circuit 302 includes the second dryer group 201b and may include a heat exchanger 144b. The second dryer group 201b is configured to adsorb moisture in the adsorption bed from the hydrogen gas during an adsorption process. In an exemplary embodiment, the second dryer group 201b includes the third dryer 202c and the fourth dryer 202d. The third dryer 202c and the fourth dryer 202d are arranged in parallel during the adsorption process allowing parallel flow of gas through the dryers 202c, 202d. For example, the supply pipes 160, 162 receive the gas flow from the reactor circuit 300. The supply valves 164, 166 are both open to allow gas flow through both supply pipes 160, 162. By splitting the gas feed to the inlets of both dryers 202c, 202d, both of the dryers 202c, 202d may simultaneously operate in the adsorption mode to adsorb moisture from the gas streams passing through the respective dryers 202c, 202d. Providing both dryers 202c, 202d, operating in the adsorption mode, may increase the amount of gas throughput in the HPS system 100. For example, the gas flow rate and/or the gas volume processed through the HPS system 100 may be increased by utilizing multiple dryers 202a, 202b in the adsorption mode. The gas discharged from the dryers 202c, 202d is directed from the discharge pipes 170, 172 to the discharge connecting pipe 171. The gas discharged from the dryers 202c, 202d may be directed to the hydrogen gas discharge 206. In various embodiments, at least a portion of the discharge gas may be diverted to the regeneration circuit 304 for use in the regeneration process.

The regeneration circuit 304 includes the first dryer group 201a, the regeneration heater 142, regeneration heat exchangers 144, the demister 130, and a compressor 132. The first dryer group 201a is configured to remove moisture from the adsorption bed during a regeneration process. The demister 130 is provided downstream of the first dryer group 201a to remove the moisture from the gas stream during the regeneration process. The compressor 132 is downstream of the demister to control a pressure and/or the flow rate of the gas flow through the system, such as the gas flow being supplied to the reactor circuit 300 and/or the adsorption circuit 302.

The first dryer group 201a is shown in the regeneration circuit 304 in the independent regeneration mode with the regeneration gas flowing through the first dryer 202a independent of the second dryer 202b. For example, no regeneration gas is flowing through the second dryer 202b (e.g., the second supply valve 186 may be closed). However, regeneration gas may be directed to the second dryer 202b independent of the first dryer 202a in other various embodiments. In the independent regeneration mode, the supply pipe 180 receives the regeneration gas flow to flow only through the first dryer 202a without passing such regeneration gas flow through the second dryer 202b. Because early stage regeneration gas flow discharged from the first dryer 202a has a high moisture content, the discharge gas flow bypasses the second dryer 202b and is routed through the discharge pipes 190, 191 downstream to the demister 130 rather than being routed, in series, to the second dryer 202b through the dryer connecting pipe 158. As such, the system avoids sending excessive moisture to the second dryer 202b, which may preserve the desiccant bed life of the second dryer 202b.

In an exemplary embodiment, the heater 142 of the regeneration circuit 304 is located upstream of the dryers 110 to heat the gas flow prior to the dryers 202. For example, the heater 142 may heat the gas flow to approximately 230° C. In an exemplary embodiment, a heat recovery heat exchanger 144c is located upstream of the heater 142 to preheat the gas flow, which may reduce the energy input to heat the gas flow to the dryers 202. In the illustrated embodiment, the gas discharge from the dryers 202 is routed to the heat recovery heat exchanger 144c for heat input to the heat exchanger. As such, the gas discharge from the dryers 202 may be cooled prior to routing to the demister 130. The gas discharge from the dryers 202 may be routed to a chilled water heat exchanger 144d to cool the gas flow prior to routing to the demister 130.

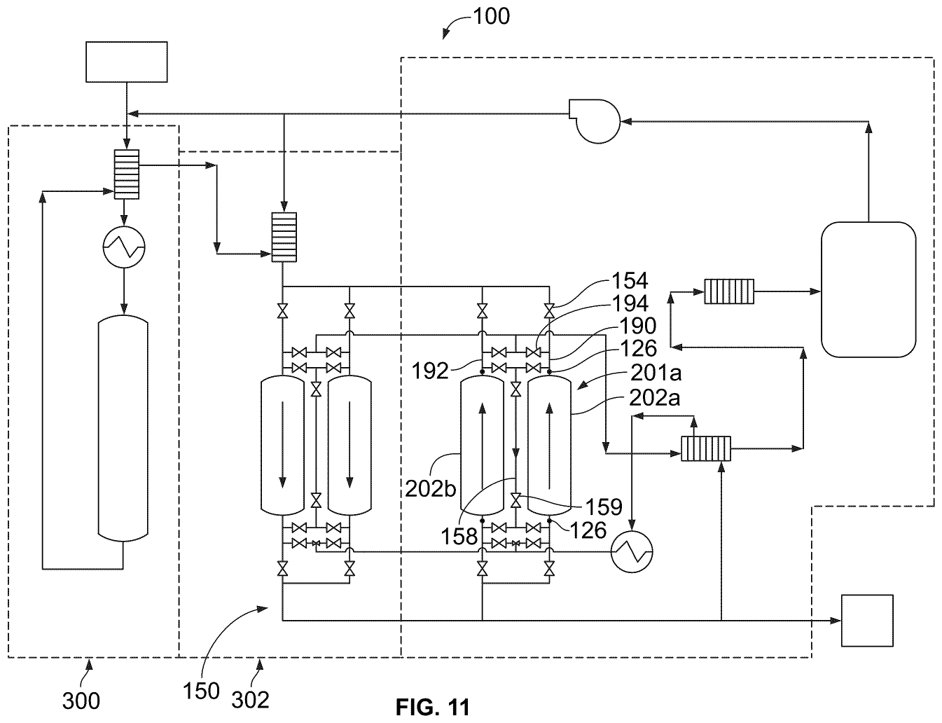

FIG. 11 is a diagram of the HPS 100 in accordance with an exemplary embodiment. FIG. 11 shows the first dryer group 201a in the series regeneration mode. The reactor circuit 300 and the adsorption circuit 302 may operate the same as shown in FIG. 10. However, the conduit system 150 is operated to change the flow of gas through the first dryer group 201a to series flow. For example, the first discharge valve 194 may be closed and the second discharge valve may be opened. Additionally, the flow control valves 157, 159 may be opened to allow flow through the dryer connecting pipe 158 from the outlet of the first dryer 202a to the inlet of the second dryer 202b to allow series flow from the first dryer 202a to the inlet of the second dryer 202b.

In an exemplary embodiment, the first dryer group 201a is switched from the independent regeneration mode (FIG. 10) to the series regeneration mode (FIG. 11) when the moisture content of the discharge gas from the first dryer 202a is below a threshold moisture content. For example, the controller 122 is operably coupled to the control valves 154 to open and close the control valves 154 to control the flow of gas through the conduit system 150. The flow control valves 157, 159 may be opened to allow flow through the dryer connecting pipe 158. The regeneration gas flow is supplied to the second dryer 202b for series flow through both the first dryer 202a and the second dryer 202b to avoid wasting the heated regeneration gas flow. The series regeneration flow uses the same heated regeneration gas flow for regenerating both first dryer 202a and the second dryer 202b to reduce the total energy consumption for regenerating the dryer group 201.

In an exemplary embodiment, the sensors 126 sense operating parameters of the gas stream. For example, the sensors 126 may sense operating parameters of the gas discharged from the dryer(s) 202. The sensors may be provided at the outlets of the dryers 202 or in the discharge pipes 190, 192 to sense parameters of the discharge gas stream. In an exemplary embodiment, the sensors 126 may include temperature sensors, moisture sensors, flow rate sensors, or other types of sensors. The sensors 126 are configured to measure (e.g., sense, detect, etc.) various parameters (e.g., gas temperature, gas moisture content, gas flow rate, etc.). The sensors 126 are operably coupled to the controller 122. The controller 122 is configured to receive signals from the sensors 126 to control operation of the components, such as the control valves 154, based on the signals received from the sensors 126.

In an exemplary embodiment, the sensors 126 are moisture sensors downstream of the outlets of the dryers 202 to sense the moisture content of the regeneration gas discharged from the dryers 202. The controller 122 is operably coupled to the moisture sensors 126 to control the conduit system 150, such as to open or close various control valves 154, based on the moisture content. For example, the controller 122 may switch from the independent regeneration mode (FIG. 10) to the series regeneration mode (FIG. 11) when the moisture content of the discharge gas measured by the moisture sensors 126 is below a threshold moisture content. In various embodiments, the threshold moisture content may be approximately 80%. In other various embodiments, the threshold moisture content may be approximately 50%. In other various embodiments, the threshold moisture content may be approximately 25%. In some embodiments, the threshold moisture content may be 0% ensuring that the first dryer 202a is completely dry/regenerated prior to the series flow. For example, after the heating phase of the regeneration process of the first dryer 202a is completed and the cool-down phase of the regeneration process has begun, the remaining heat during the cool down process can be used to begin the regeneration process of the second dryer 202b.

In an exemplary embodiment, the sensors 126 are temperature sensors downstream of the outlets of the dryers 202 to sense the temperature of the regeneration gas discharged from the dryers 202. The controller 122 is operably coupled to the temperature sensors 126 to control the conduit system 150, such as to open or close various control valves 154, based on the temperature. For example, the controller 122 may switch from the independent regeneration mode (FIG. 10) to the series regeneration mode (FIG. 11) when the temperature of the discharge gas measured by the temperature sensors 126 is below a threshold temperature. In various embodiments, the controller 122 may use the temperature readings to calculate or determine a moisture content. For example, the temperature may be correlated to the quantity of moisture removed by the regeneration gas. In an exemplary embodiment, temperature sensors 126 may be provided upstream and downstream of the first dryer 202a and the temperature readings from the temperature sensors 126 may be compared to calculate/determine a moisture content of the discharged regeneration gas based on the temperature difference. For example, when the moisture content of the discharged regeneration gas is high, the temperature difference may be large, whereas, when the moisture content of the discharged regeneration gas is low, the temperature difference may be small.

In an exemplary embodiment, rather than using sensors in the system to measure parameters of the regeneration gas, the controller 122 may be operated based on a timer. For example, the controller 122 may switch from the independent regeneration mode (FIG. 10) to the series regeneration mode (FIG. 11) after a predetermined time from onset of the regeneration process, which may correspond to a desired moisture content based on calibration or testing data.

In an exemplary embodiment, the controller 122 may be operated based on a control model. For example, the controller 122 may switch from the independent regeneration mode (FIG. 10) to the series regeneration mode (FIG. 11) based on operation history of the HPS 100 and/or other operating or environmental conditions to predict moisture content during operation.

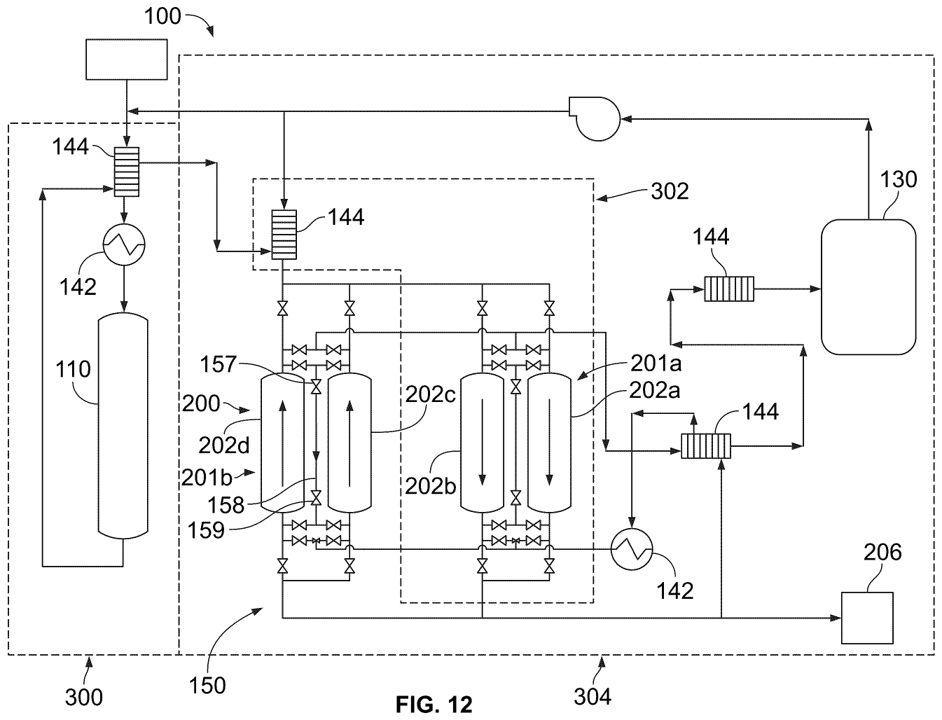

FIG. 12 is a diagram of the HPS 100 in accordance with an exemplary embodiment. FIG. 12 shows the reactor 110, the dryer system 200, the heaters 142, the heat exchangers 144, and the demister 130, as well as the conduit system 150 connecting the components of the HPS 100. FIG. 12 shows the second dryer group 201b of the dryer system 200 in the regeneration mode (series regeneration mode) and the first dryer group 201a of the dryer system 200 in the adsorption mode.

The adsorption circuit 302 includes the first dryer group 201a configured to adsorb moisture in the adsorption bed from the hydrogen gas during an adsorption process. In an exemplary embodiment, the first dryer group 201a includes the first dryer 202a and the second dryer 202b. The first dryer 202a and the second dryer 202b are arranged in parallel during the adsorption process allowing parallel flow of gas through the dryers 202a, 202b. The gas discharged from the dryers 202a, 202b may be directed to the hydrogen gas discharge 206. In various embodiments, at least a portion of the discharge gas may be diverted to the regeneration circuit 304 for use in the regeneration process.

The regeneration circuit 304 includes the second dryer group 201b configured to remove moisture from the adsorption bed during a regeneration process. The second dryer group 201b is shown in the regeneration circuit 304 in the series regeneration mode with the regeneration gas flowing through the third dryer 202c independent of the fourth dryer 202d. For example, the flow control valves 157, 159 are opened to allow flow through the dryer connecting pipe 158 from the outlet of the third dryer 202c to the inlet of the fourth dryer 202d to allow series flow from the third dryer 202c to the inlet of the fourth dryer 202d.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable sub-combination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single monolithically body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S. C. § 112(f), unless and until such claim limitations expressly use the phrase “means for” followed by a statement of function void of further structure.

What is claimed is:

1. A hydrogen purification system comprising:
a dryer system including a plurality of dryers, each dryer including an adsorption bed for drying hydrogen gas, the dryer configured to adsorb moisture in the adsorption bed from the hydrogen gas in an adsorption mode, the dryer configured to remove moisture from the adsorption bed in a regeneration mode, the plurality of dryers include a first dryer group including a first dryer and a second dryer; and
a conduit system configured to connect the plurality of dryers to a hydrogen gas feed and to a hydrogen gas discharge;
wherein the first dryer and the second dryer are arranged in parallel in the adsorption mode allowing parallel flow of the hydrogen gas through the first dryer and the second dryer; and
wherein the first dryer and the second dryer are arranged in series in the regeneration mode allowing series flow of regeneration gas through the first dryer and the second dryer.

2. The hydrogen purification system of claim 1, wherein the regeneration gas flows from the first dryer to the second dryer in series flow in the regeneration mode.

3. The hydrogen purification system of claim 1, wherein the conduit system includes a first supply conduit connected to an adsorption inlet of the first dryer and a second supply conduit connected to an adsorption inlet of the second dryer, the conduit system configured to simultaneously supply the hydrogen gas to the first and second supply conduits in the adsorption mode for parallel flow of gas through the first dryer and the second dryer.

4. The hydrogen purification system of claim 1, wherein the conduit system includes pipes and control valves to control the flow of gas through the pipes, the control valves configured to be selectively opened and closed to change between the adsorption mode and the regeneration mode through the first and second dryers.

5. The hydrogen purification system of claim 1, wherein the conduit system includes a dryer connecting pipe between the first dryer and the second dryer to allow gas flow from the first dryer to the second dryer in the regeneration mode.

6. The hydrogen purification system of claim 1, wherein the plurality of dryers includes a second dryer group including a third dryer and a fourth dryer, wherein the third dryer and the fourth dryer are arranged in parallel in the adsorption mode allowing parallel flow of the hydrogen gas through the third dryer and the fourth dryer, and wherein the third dryer and the fourth dryer are arranged in series in the regeneration mode allowing series flow of regeneration gas through the third dryer and the fourth dryer.

7. The hydrogen purification system of claim 6, wherein the first dryer group is configured to be operated in the adsorption mode when the second dryer group is in the regeneration mode, and wherein the second dryer group is configured to be operated in the adsorption mode when the first dryer group is in the regeneration mode.

8. The hydrogen purification system of claim 1, wherein the regeneration mode includes an independent regeneration mode and a series regeneration mode, the conduit system configured to supply regeneration gas flow to the first dryer independent of the second dryer in the independent regeneration mode, the conduit system configured to supply regeneration gas flow from the first dryer to the second dryer in series in the series regeneration mode.

9. The hydrogen purification system of claim 8, wherein the conduit system switches from the independent regeneration mode to the series regeneration mode when a moisture content of the regeneration gas discharged from the first dryer is below a threshold moisture content.

10. The hydrogen purification system of claim 9, further comprising a moisture sensor downstream of an outlet of the first dryer to sense the moisture content of the regeneration gas discharged from the first dryer, the controller operably coupled to the moisture sensor to control the conduit system based on the moisture content.

11. The hydrogen purification system of claim 8, further comprising a temperature sensor downstream of an outlet of the first dryer to sense a temperature of the regeneration gas discharged from the first dryer, the conduit system switching from the independent regeneration mode to the series regeneration mode when the temperature of the regeneration gas discharged from the first dryer is above a threshold temperature.

12. The hydrogen purification system of claim 8, wherein the conduit system switches from the independent regeneration mode to the series regeneration mode after a predetermined time after onset of the independent regeneration mode.

13. The hydrogen purification system of claim 1, wherein the first dryer group includes a third dryer, the third dryer being operated in one of a regeneration mode or an adsorption mode when the first dryer and the second dryer are in the adsorption mode, the third dryer being operated in one of a regeneration mode or an adsorption mode when the first dryer and the second dryer are in the regeneration mode.

14. The hydrogen purification system of claim 1, further comprising a reactor upstream of the dryer system having a catalyst member configured to convert oxygen in the hydrogen gas flow to water.

15. The hydrogen purification system of claim 1, further comprising a regeneration heater configured to heat the regeneration gas prior to flow through the dryer system, wherein the heated regeneration gas flows from the first dryer to the second dryer when in series flow in the regeneration mode.

16. A hydrogen purification system comprising:
a dryer system including a plurality of dryers, each dryer including an adsorption bed for drying hydrogen gas, the dryer configured to adsorb moisture in the adsorption bed from the hydrogen gas in an adsorption mode, the dryer configured to remove moisture from the adsorption bed in a regeneration mode, the plurality of dryers include a first dryer group including a first dryer and a second dryer;
a conduit system including pipes and control valves, the conduit system configured to connect the plurality of dryers to a hydrogen gas feed and to a hydrogen gas discharge; and
a controller operably coupled to the conduit system to control the control valves to control flow of gas through the pipes;
wherein the first dryer and the second dryer are arranged in parallel in the adsorption mode allowing parallel flow of gas through the first dryer and the second dryer; and
wherein the regeneration mode includes an independent regeneration mode and a series regeneration mode, the controller operating the conduit system to supply regeneration gas flow to the first dryer independent of the second dryer in the independent regeneration mode, the controller operating the conduit system to supply regeneration gas flow from the first dryer to the second dryer in series in the series regeneration mode.

17. The hydrogen purification system of claim 16, wherein the controller switches from the independent regeneration mode to the series regeneration mode when a moisture content of the regeneration gas discharged from the first dryer is below a threshold moisture content.

18. The hydrogen purification system of claim 17, wherein further comprising a moisture sensor downstream of an outlet of the first dryer two cents the moisture content of the regeneration gas discharged from the first dryer, the controller operably coupled to the moisture sensor to control the conduit system based on the moisture content.

19. The hydrogen purification system of claim 16, further comprising a temperature sensor downstream of an outlet of the first dryer two cents a temperature of the regeneration gas discharged from the first dryer, the controller operably coupled to the temperature sensor to control the conduit system based on the temperature.

20. The hydrogen purification system of claim 19, wherein the controller determines a moisture content of the regeneration gas based on the temperature of the regeneration gas discharged from the outlet of the first dryer, the controller switching from the independent regeneration mode to the series regeneration mode when the temperature of the regeneration gas discharged from the first dryer is above a threshold temperature.

21. The hydrogen purification system of claim 16, wherein the controller switches from the independent regeneration mode to the series regeneration mode after a predetermined time after the onset of the independent regeneration mode.

22. A method of purifying hydrogen gas using a hydrogen purification system including a dryer system including a plurality of dryers and a conduit system configured to connect the plurality of dryers to a hydrogen gas feed and to a hydrogen gas discharge, each dryer including an adsorption bed for drying hydrogen gas, the plurality of dryers include a first dryer group including a first dryer and a second dryer, the method comprising:
adsorbing moisture in the adsorption beds of the first and second dryers from the hydrogen gas in an adsorption mode, wherein the first dryer and the second dryer are arranged in parallel in the adsorption mode allowing parallel flow of the hydrogen gas through the first dryer and the second dryer;
removing moisture from the adsorption beds of the first and second dryers in a regeneration mode, wherein the first dryer and the second dryer are arranged in series in the regeneration mode allowing series flow of regeneration gas through the first dryer and the second dryer.

23. The method of claim 22, wherein the regeneration mode includes an independent regeneration mode and a series regeneration mode, the method further comprising:
supplying regeneration gas flow to the first dryer independent of the second dryer in the independent regeneration mode; and
supplying regeneration gas flow from the first dryer to the second dryer in series in the series regeneration mode.

24. The method of claim 23, further comprising switching from the independent regeneration mode to the series regeneration mode when a moisture content of the regeneration gas discharged from the first dryer is below a threshold moisture content.

25. The method of claim 22, wherein the conduit system includes pipes and control valves to control the flow of gas through the pipes, the method including selectively opening and closing the control valves to change flow of gas through the first and second dryers for the adsorption mode and the regeneration mode.
